(19) United States
(12) Patent Application Publication
(10) Pub. No.: US 2005/0287973 A1
(43) Pub. Date: Dec. 29, 2005

(54) Radio receiver capable of suppressing deterioration in reflection characteristics of output therefrom

(75) Inventor: Yoshihito Kasuga, Kariya-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/165,540

(22) Filed: Jun. 24, 2005

(30) Foreign Application Priority Data
Jun. 25, 2004 (JP) 2004-187837

(51) Int. Cl. H04B 17/00; H04B 1/18; H04B 1/16

(52) U.S. Cl. 455/226.1; 455/291; 455/341

(57) ABSTRACT

A radio receiver, which is for example a GPS receiver, comprises a reception antenna receiving a radio wave whose wavelength γ to output an electrical signal depending on the received radio wave, an amplifier amplifying the electrical signal outputted from the reception antenna, and a cable connected via a connection terminal to the amplifier to transmit an electrical signal amplified by the amplifier. The connection terminal is positioned at the amplifier so as to intervene between the cable and an inner amplifying inner amplifying circuit of the amplifier. Only a first specified portion of the cable is short-circuited to a metal member in a range of signals of high frequencies to be transmitted through the cable, in which the first specified portion is measured from the connection terminal so as to have a distance corresponding to (k/4)λ (k is an odd number).

### CROSS-REFERENCE TO RELATED APPLICATION

This application is based upon and claims the benefit of priority from earlier Japanese Patent Application No. 2004-187837 filed on Jun. 25, 2004, the description of which being incorporated herein by reference.

### BACKGROUND OF THE INVENTION

1. Field of the Invention

The present invention relates to a radio receiver for receiving and amplifying high-frequency radio signals. More particularly, the present invention relates to a radio receiver which is particularly suitable for use in onboard GPS (Global Positioning System) receivers.

2. Related Art

Radio receivers which receive and amplify high-frequency signals have been known. One example of such radio receivers is a GPS receiver which is adapted to be loaded on a vehicle in order to specify a current location of the vehicle. Such a GPS receiver mounted in an automobile receives, by its antenna, a radio signal of 1.5 GHz from a GPS satellite, amplifies the received radio signal, and outputs the amplified high-frequency signal to a car navigation system through a coaxial cable.

In such a radio receiver, however, the reflection characteristics of the radio receiver (referred to as “output reflection characteristics”) may be deteriorated depending on its positional relation to conductors located near the radio receiver. As a result, the reception sensitivity may also be deteriorated.

Such a situation is specifically described herein by way of an example of a GPS receiver. FIG. 1 shows a GPS receiver 60 which is set up on a vehicle body 50 serving as a conductor. The GPS receiver 60 comprises: an antenna element 52 which is provided inside a radome 51 and receives radio waves of 1.5 GHz band; LNAs (low noise amplifiers) 53 which amplify electrical signals received by the antenna element 52; and a coaxial cable 54 which transmits the signals from the amplifier circuits to a coaxial cable 59 through a connector 57. A car navigation system, for example, is located at the end of output from the coaxial cable 59.

A current that passes through a center conductor 55 of the coaxial cable 54 is typically directed to the coaxial cable 59 through a metal joint 58 of a connector 57. However, considering costs or the like, a simplified connector may be employed as the connector 57, rather than the one having reflection characteristics desirable for high-frequency transmission. In such cases, a high-frequency current unavoidably leaks out from the joint 58 to the outside of an outer coating 56 of the coaxial cable 54.

On the other hand, the coaxial cable, when wired close to the vehicle body 50 as shown in FIG. 1, allows the presence of floating impedance 61, such as capacitance, between the coaxial cable 54 and the vehicle body 50, which is unignorable in high-frequency region.

Thus, a current that has leaked from the joint 58 unavoidably turns to a floating current between the outer coating 56 and the vehicle body 50. The floating current is then emitted as radio-frequency (arrow 62) from the end of the coaxial cable 54 at the side connected to the LNAs 53. The resultant electric field is coupled to the antenna element 52. As a result, the leaked floating current is unavoidably returned to the connector 57 after having been amplified by the LNAs 53.

In such a circumstance, a current that flows through the center conductor 55 becomes improperly large and deteriorates the output reflection characteristics, resulting in the deterioration in reception sensitivity. In some cases, the GPS antenna itself may cause parasitic oscillation.

### SUMMARY OF THE INVENTION

The present invention has been made in view of the circumstances described above, and has an object that provides a radio receiver of suppressing deterioration in the output reflection characteristics thereof, which is caused by coupling of the radiation field with the antenna, which has been emitted from the end of a cable connected to an antenna of the radio receiver due to leakage current from the cable.

In order to achieve the foregoing object, a radio receiver according to the present invention comprises a reception antenna receiving a radio wave whose wavelength is γ to output an electrical signal depending on the received radio wave; an amplifier amplifying the electrical signal outputted from the reception antenna; and a cable connected via a connection terminal to the amplifier to transmit an electrical signal amplified by the amplifier. The connection terminal is positioned at the amplifier so as to intervene between the cable and an inner amplifying inner amplifying circuit of the amplifier, only a first specified portion of the cable is short-circuited to a metal member in a range of signals of high frequencies to be transmitted through the cable, and the first specified portion is measured from the connection terminal so as to have a distance corresponding to (k/4)λ (k is an odd number).

Hereinafter, the state under which the cable is short-circuited in a band of signals of high frequencies will now be referred to as high-frequency short circuit.

Thus, when high-frequency short circuit occurs for the first time at a position distanced by k/4λ from the contact, the voltage amplitude of standing waves of the floating current becomes the maximum at this short-circuited portion. Contrarily, at the contact position distanced by k/4λ from the short-circuited portion, the voltage amplitude becomes approximately null (i.e., zero). Accordingly, the electric field which is radiated from the contact, i.e. the end point of the cable at the side of the amplifier circuit, can be suppressed. As a result, deterioration of the output reflection characteristics caused by the coupling of the electric field with a receiving antenna can be suppressed.

When the number k is 1, the highest effects of reducing deterioration in the reflection characteristics can be obtained.

The cable may be further permitted to make a high-frequency short circuit with the metal body downstream of the portion where short circuit has initially permitted to occur, so that effects of reducing deterioration in the reflection characteristics can be improved.

In addition, if the downstream high-frequency short circuit mentioned above is at a position traced by j/4λ (where j is an odd number larger than k) from the position of the contact with the amplifier circuit, the effects of reducing deterioration in the reflection characteristics are more improved.

The cable may be substantially linearly disposed from the contact position to the portion of the initial high-frequency short circuit, so that the effects of reducing deterioration in the reflection characteristics may be improved.

The high-frequency short circuit may be realized by using a clip in which the cable is hung to have its outer coating contacted with the ground. Alternatively, the high-frequency short circuit may be realized by having the cable stuck onto a metal body by means of a tape, or may be realized by interposing a conductive member between the cable and the metal body.

### BRIEF DESCRIPTION OF THE DRAWINGS

In the accompanying drawings:

FIG. 1 is a block diagram showing a configuration of a GPS receiver according to conventional art;

FIG. 2A is a top view of the GPS receiver loaded on a vehicle body;

FIG. 2B is a side view of the GPS receiver loaded on a vehicle body FIG. 3A is an enlarged top view of a short-circuited portion;

FIG. 3B is an enlarged front view of a short-circuited portion;

FIG. 3C is an enlarged side view of a short-circuited portion;

FIG. 4 is a block diagram showing a configuration of an experiment on output reflection characteristics such as of the GPS receiver;

FIG. 5 is a graph showing the results of the experiment on output reflection characteristics such as of the GPS receiver;

FIG. 6A is an enlarged top view of the short-circuited portion according to a second embodiment of the present invention;

FIG. 6B is an enlarged front view of the short-circuited portion according to the second embodiment of the present invention;

FIG. 6C an enlarged side view of the short-circuited portion according to the second embodiment of the present invention;

FIG. 7A is an enlarged top view of the short-circuited portion according to a third embodiment of the present invention;

FIG. 7B is an enlarged front view of the short-circuited portion according to the third embodiment of the present invention;

FIG. 7C is an enlarged side view of the short-circuited portion according to the third embodiment of the present invention;

FIG. 8A is an enlarged top view of the short-circuited portion according to a fourth embodiment of the present invention;

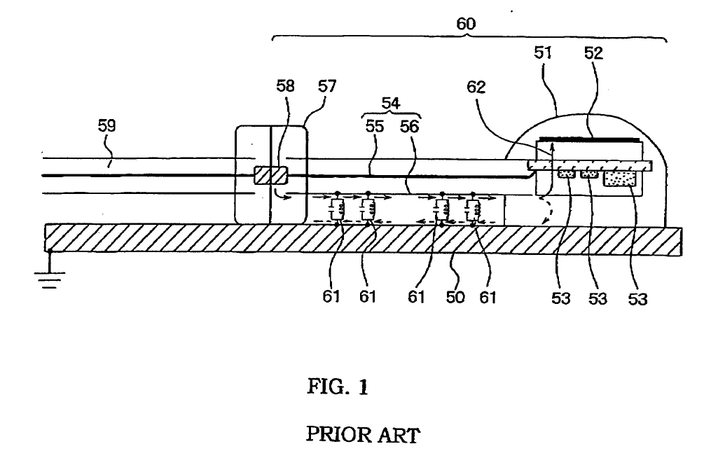

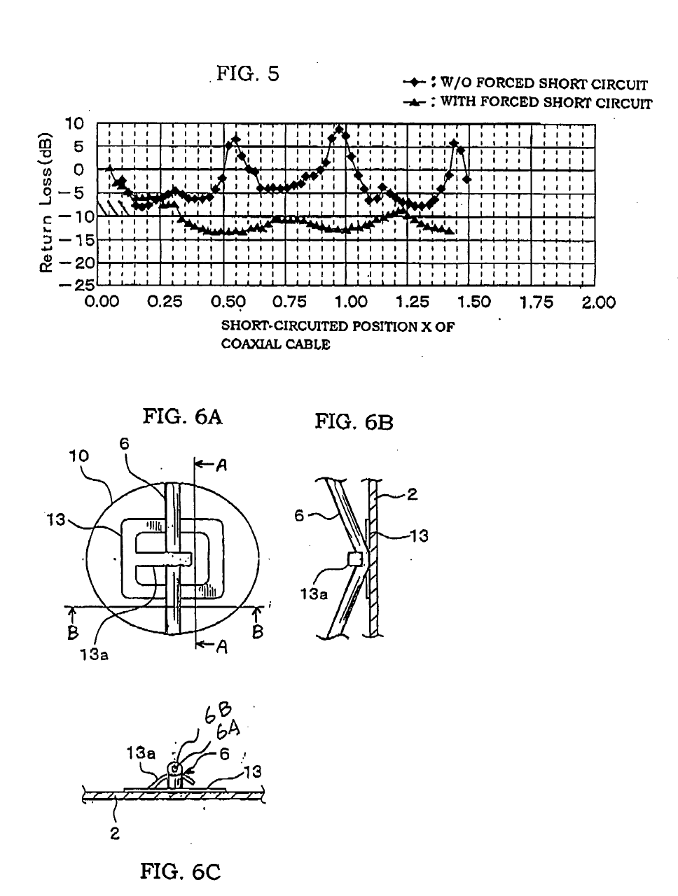

FIG. 5B is an enlarged front view of the short-circuited portion according to the fourth embodiment of the present invention;

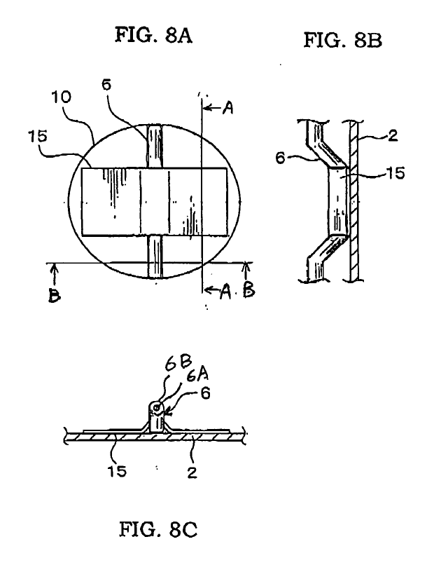

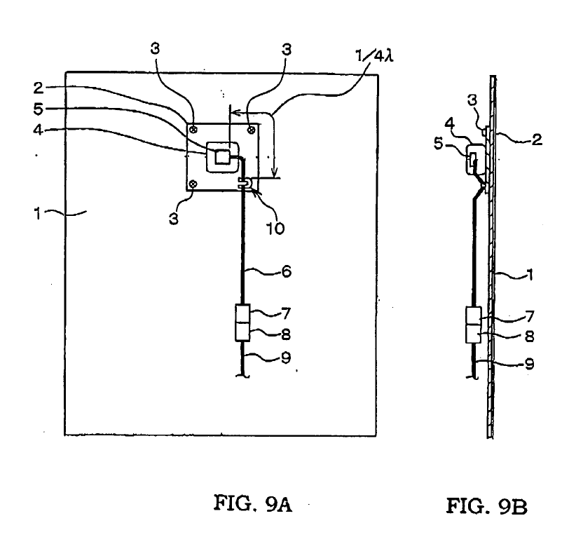

FIG. 8C is an enlarged side view of the short-circuited portion according to the fourth embodiment of the present invention;

FIG. 9A is a top view showing a configuration of the GPS receiver according to a fifth embodiment of the present invention; and

FIG. 9B is a side view showing the configuration of the GPS receiver according to the fifth embodiment of the present invention.

### DETAILED DESCRIPTION OF PREFERRED EMBODIMENTS

### First Embodiment

A GPS receiver according to a first embodiment of the present invention will now be described.

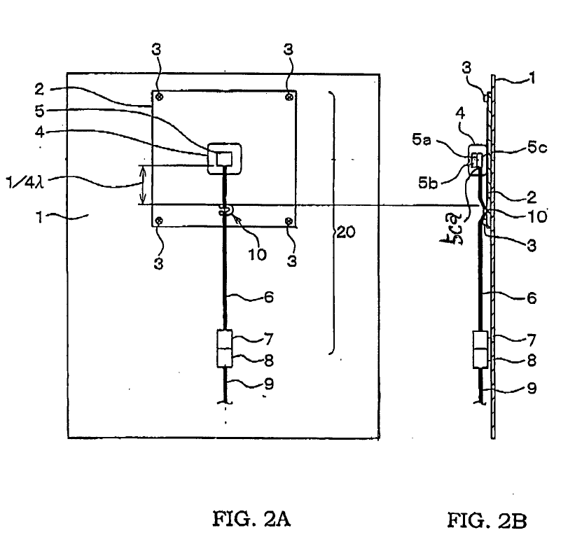

As shown in FIGS. 2A and 2B, a GPS receiver 20 is attached to the body 1 of a vehicle (vehicle body).

The vehicle body 1 is made of metal, so that the vehicle body 1 is a metal member which electrically serves as the ground. The GPS receiver (radio receiver) 20 is secured on the vehicle body 1 and comprises a bracket 2, screws 3, a GPS receiver case 4, a receiving circuit 5, a cable 6, and a connector 7. FIG. 2A is a top view of the GPS receiver 20, and FIG. 2B is a side view thereof.

The bracket 2 is a metal plate which is fixed to the vehicle body 1 through four screws 3 at its four corners so as to establish conduction through the vehicle body 1. The GPS receiver case 4 made of resin, which serves as a radome, is fixed onto the bracket 2. The GPS receiver case 4A is provided therein with a substrate 5a, a planar antenna 5b which is arranged at an upper surface of the substrate 5a, and an amplifier circuit 5c which is arranged at a lower surface of the substrate 5a.

The planar antenna 5b is configured such that a radio wave having frequency of about 1.5 GHz and wavelength of about 20 cm is received from a OPS satellite. The amplifier circuit 5c is a low noise amplifier which is arranged such that an electrical signal received by the planar antenna 5b is amplified (e.g. at 31-dBi gain), and that the amplified high-frequency signal is outputted to the cable 6.

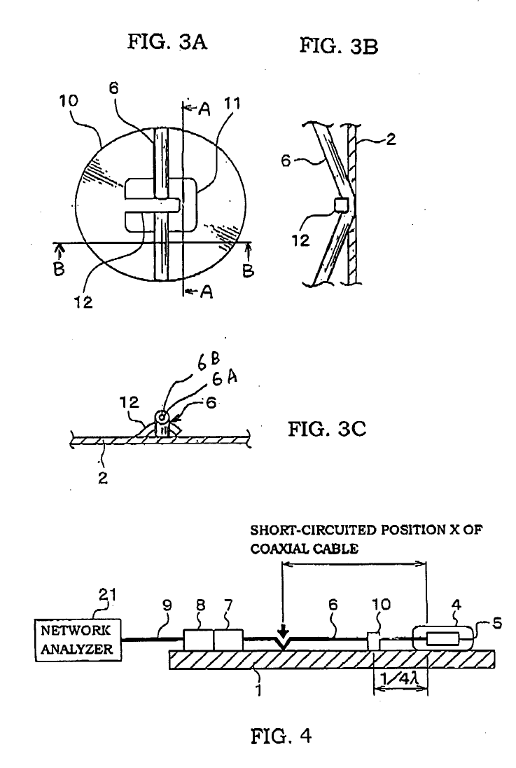

The cable 6, which is formed into a coaxial cable including an inner core cable 6A and an outer coating 6B (refer to FIG. 3C), receives a high-frequency signal at one end point thereof, which has been outputted from the amplifier circuit 5c, and transmits the received high-frequency signal toward the other end point thereof. The entire length of the cable 6 is 30 cm, for example. It should be noted that the outer coating of the cable 6 is discontinued at the end point of the cable 6 at the side of the amplifier circuit 5c.

The connector 7 is connected to the other end point mentioned above, and is adapted to output the signal from the cable 6 to a cable 9 through a connector 8. The connector 7 and the connector 8 cannot be regarded as having ideal reflection characteristics to serve as connectors between cables for transmitting high-frequency signals. Particularly, when a high-frequency signal of 1.5-GHz band is transmitted from the connector 7 to the connector 8, the high-frequency current may partially leak from the junction of these two connectors.

The cable 6 is arranged in such a way that a large part thereof slightly (e.g., a few centimeters) floats above both of the vehicle body 1 and the bracket 2. A portion of the cable 6, however, is forcibly in contact with the bracket 2 through a short-circuited portion 10 realizing a point-to-point contact. The “contact” herein means that the outer coating of vinyl of the cable 6 is made to be in contact with the bracket 2, i.e. a metal body, in a positive manner. In such a circumstance, both of the cable 6 and the bracket 2 are in a state of high-frequency short circuit at the contact position.

The position of the short-circuited portion 10 corresponds to a position traced by (¼)λ from the contact 5ca of the cable 6 with the amplifier circuit 5c.

The section from the end point of the cable 6 in contact with the amplifier 5c to the short-circuited portion 10 is substantially arranged in a linear manner without being bent. In this section, the cable 6 and the bracket 2 are not in the state of high-frequency short circuit. Specifically, the cable 6 makes high-frequency short circuit for the first time at the position traced by (¼)λ from the contact point 5ca to the amplifier circuit Sc.

The forced contact of the cable 6 to the bracket 2 at the short-circuited portion 10 is described in detail. FIGS. 3A, 3B and 3C are enlarged view of the short-circuited portion 10. FIG. 3A is a top view of the short-circuited portion 10. FIG. 3B is a cross-sectional view taken along an A-A line in FIG. 3A. FIG. 3C is a cross-sectional view taken along a B-B line in FIG. 3A.

A circled portion in FIG. 3A is the short-circuited portion 10. In the short-circuited portion 10, the bracket 2 is provided with a U-shaped notch 11. The cable 6 is arranged so as to pass beneath a protrusion 12 provided by the notch 11. In this way, the cable 6 is pushed by the protrusion 12 from above, being caught thereby to forcibly be brought into contact with the bracket 2.

Thus, the protrusion 12 provided by the notch 11 functions as a clip, catching the cable 6 and bringing its outer coating into contact with the metal body.

At the downstream of the short-circuited portion 10 in the cable 6, i.e. between the short-circuited portion 10 and the connector 7, the cable 6 may be partially in touch with the vehicle body 1 due to the slack of the cable 6. As a result, high-frequency short circuit may be caused at the contact position 5ca between the cable 6 and the vehicle body 1. Such a natural contact position, unlike the forcible contact at the short-circuited portion 10, is likely to vary depending on a running state of the vehicle.

Hereinafter, the results of experiments which were carried out by the inventors are described. The experiments were on the output reflection characteristics of the GPS receiver 20 having the configuration as described above. FIG. 4 shows the configuration of an experiment carried out by the inventor, in which the connector 9 is provided to be connected to a network analyzer 21 via the cable 9.

The network analyzer in the present embodiment outputs a high-frequency signal to the GPS receiver 20 through the cable 9, and measures power, i.e. feedback power, of the high-frequency signal returned to the connector 7 through the cable 9. The analyzer network displays a logarithmic value of the feedback power for the output power, in terms of a return loss, For example, a network analyzer may be used, which outputs high-frequency signal at a frequency of 1.57542 GHz, outputs power of −30 dBm, and outputs voltage of 4.5V.

The presence of feedback power means that all the outputted power is being returned from the planar antenna 5b without being radiated. Accordingly, it may be regarded that the larger the value of a return loss is, the worse are the output reflection characteristics of the GPS receiver 20.

FIG. 5 is a graph showing the results of the experiments. In the graph, the vertical axis represents a return loss, by a unit of dB, the horizontal axis represents a distance x along the cable 6 from its contact with the receiving circuit 5 to the position of unforced short circuit, by a unit of λ. It should be noted that the unforced short circuit, unlike the short circuit at the forced short-circuited portion 10, is the short circuit whose position may be readily varied. For example, such unforced short circuits include one caused by a portion of the cable 6 that has naturally hung down by its weight, and brought into contact with the vehicle body 1 or the bracket 2.

In the graph, the polygonal line plotted with diamonds corresponds to the case where there is no forced short circuit at the position of ¼λ, and the line plotted with triangles corresponds to the case where there is a forced short circuit at the position of (¼)λ (i.e. the latter corresponds to the GPS receiver 20 of the present embodiment). As shown in the graph, in a range where the position (distance from the contact 5ca) x of the unforced short circuit is beyond 0.25, the return losses obtained with the forced short circuit are constantly lower than the return losses obtained without the forced short circuit. Further, in such a range where the position x of the unforced short circuit is beyond 0.25, the return losses obtained with the forced short circuit is, in most cases, below a general reference value of −9.5 dB, thus enhancing good output reflection characteristics.

Therefore, as long as the position of the initial forced contact between the cable 6 and the bracket 2 is located at (¼)λ along the cable 6 from the contact 5ca with the amplifier circuit 5c, the excellence of the output reflection characteristics may be maintained. This may be true even when the cable 6 naturally contacts the vehicle body 1 in the downstream, and the natural contact is varied accordingly depending on the running state of the vehicle. In other words, the forced short circuit of the cable 6 with the bracket 2 at the position (¼)λ from the contact of the cable 6 with the amplifier circuit 5c, may suppress deterioration in the output reflection characteristics in the GPS receiver 20, thereby preventing deterioration in the receiver sensitivity and the parasitic oscillation of the GPS antenna.

As shown by the line plotted with triangles in the graph, if another forced high-frequency short circuit is provided to the cable 6 at a position traced by (j/4)λ (where j is an odd number of 3 or more) from the contact 5ca with the amplifier circuit 5c, i.e. downstream of the initial high-frequency short circuit, the return loss results in the minimum, thereby further improving the effects of suppressing deterioration in the output reflection characteristics.

A mechanism that brings about such results of experiments is discussed hereinbelow. As described in the background of the invention, one of the causes of deterioration in the reflection characteristics is the coupling of the planar antenna 5b with a radiated electric field. This radiated electric field, as described above, is caused by a current that has leaked from the connector 7 and has turned to a standing wave along the cable 6, being affected by the floating impedance between the cable 6 and the vehicle body 1 or between the cable 6 and the bracket 2, the standing wave in turn emitting an electric wave from the end point of the cable 6 at the amplifier circuit 5c.

As in the present embodiment, if the initial forced high-frequency short circuit takes place at the position along the cable 6 traced by (¼) λ from the contact 5ca with the amplifier circuit 5c, the current of the standing waves becomes null at the short-circuited position and the voltage becomes the maximum. As a result, the voltage of the standing waves becomes approximately null at the contact 5ca with the amplifier circuit 5c, which is distanced from the short-circuited position by (¼)λ. Accordingly, the electric field radiated from the end point becomes approximately null to thereby render the coupling at the planar antenna 5b to be approximately null. Thus, deterioration in the output reflection characteristics of the GPS receiver 20 can be suppressed.

The effects as described above are not limited to be obtained where the initial high-frequency short circuit between the cable 6 and a metal body is at the position traced by (¼)λ from the contact 5ca with the amplifier circuit. Such effects can also be attained to an extent where the initial short circuit takes place at a position of (k/4)λ (where k is an odd number of 3 or more). This is because the cycle of amplitude of standing wave is 1/λ.

### Second Embodiment

A GPS receiver according to a second embodiment of the present invention will now be described hereinbelow.

The present embodiment is different from the first embodiment in the method of the forced contact between the cable 6 and the bracket 2 at the short-circuited portion 10.

FIGS. 6A, 6B and 6C show enlarged views of the short-circuited portion 10 of the GPS receiver 20 of the present embodiment, in the same manner as in FIGS. 3A, 33 and 3C. In the present embodiment and successive embodiments, the components which are similar and identical in their constructions and functions to those in the first embodiment are referred to by the same reference numbers.

The short-circuited portion 10 is shown in a circle in FIG. 6A. In the short-circuited portion 10, a clamp 13 is fixed to the bracket 2, such as by an adhesive.

The clamp 13 consists of a body having a square-O shape, and a projection 13a extending from one side of the body. The cable 6 is arranged to pass beneath the projection 13a. The cable 6 is thus caught by the projection 13a being pressed thereby from above so as to be forcibly in contact with the bracket 2.

Accordingly, the clamp 13 functions as a clip, thus hooking the cable 6 and bringing its outer coating into contact with a metal body.

### Third Embodiment

A GPS receiver according to a third embodiment of the present invention will now be described hereinbelow.

The present embodiment is different from the first embodiment in the method of the forced high-frequency short circuit between the cable 6 and the bracket 2 at the short-circuited portion 10.

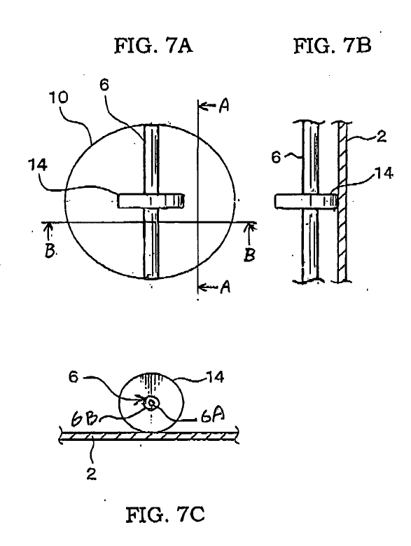

Enlarged views of the short-circuited portion 10 of the GPS receiver 20 of the present embodiment are shown in FIGS. 7A, 7B and 7C in the same manner as in FIGS. 3A, 3B and 3C.

The short-circuited portion 10 is circled in FIG. 7A. In the short-circuited portion 10, a conductive cushion 14 encloses the axis of the cable 6.

The conductive cushion 14 is of a disk-like shape with a hole therein and has conductivity. The cable 6 is allowed to tightly pass through the hole of the conductive cushion 14. The radial length of the conductive cushion 14 is made a little larger than the distance between the cable 6 and the bracket 2.

The configuration as described above permits the lower portion of the conductive cushion 14, through which the cable 6 passes, to be in contact with the bracket 2. In other words, the interposition of a portion of the conductive cushion 14, as a conductive member, between the cable 6 and the bracket 2 realizes the high-frequency short circuit between the cable 6 and the bracket 2.

### Fourth Embodiment

A GPS receiver according to a fourth embodiment of the present invention will now be described hereinbelow.

The present embodiment is different from the first embodiment in the method of the forced contact between the cable 6 and the bracket 2 at the short-circuited portion 10. Enlarged views of the short-circuited portion 10 of the GPS receiver 20 of the present embodiment are shown in FIGS. 8A, 8B and 8C in the same manner as in FIGS. 3A, 3B and 3C.

The short-circuited portion 10 is circled in FIG. 8A. In the short-circuited portion 10, the cable 6 is stuck onto the bracket 2 by a conductive tape 15.

Thus, the cable 6 is held by the adhesion of the conductive tape 15 so as to be forcibly in contact with the bracket 2.

### Fifth Embodiment

A GPS receiver according to a fifth embodiment of the present invention will now be described hereinbelow.

The present embodiment is different from the first embodiment in the method of leading the cable 6.

FIGS. 9A and 9B show an arrangement of the cable 6 of the GPS receiver 20 of the present embodiment in the same manner as in FIGS. 2A and 2B.

As shown, the cable 6 is bent into 90 degrees between its contact with the receiving circuit 5 and the short-circuited portion 10 which is provided at a position along the cable 6 traced by λ/4 from the receiving circuit 5.

Thus, by allowing the cable 6 to be bent from the contact to the short-circuited portion 10, even a smaller bracket 2, which would not include the position (¼)λ from the contact, had the cable 6 been linearly arranged, can include therein the short-circuited portion 10. Such a configuration provides an advantage, in particular, that no processing of the vehicle body 1 (metal body) is required, which would otherwise be required, when, for example, establishing a forced high-frequency short circuit between the cable 6 and the vehicle body (metal body), by using the notch 11 as in the first embodiment.

In the embodiments described above, the planar antenna 5b corresponds to a receiving antenna.

Each of the body 1 and the bracket 2 corresponds to a metal body. In the embodiments described above, although the short-circuited portion 10 is provided on the bracket 2, the short-circuited portion 10 may be on the vehicle body 1.

In the embodiments described above, the frequency of the radio waves received by the planar antenna 5b is 1.5 GHz, however, the waves received by the planar antenna 5b are not limited to this frequency but may only be in a band of high frequencies, e.g., 800 MHz.

In the embodiments described above, the high-frequency short circuit is realized by having the outer coating of the cable 6 contacted a metal body, however, the outer coating of the cable 6 and the metal body does not necessarily have to be in contact with each other. Particularly, the cable 6 and the metal body may be slightly apart from each other to an extent that causes high-frequency short circuit (e.g., several millimeters).

In the embodiments described above, the short circuit position is set at (k/4)λ (where k is an odd number) from the contact of the cable 6 with the receiving circuit 5, however, the position does not necessarily have to be strictly set at this value. The position may be offset from (k/4)λ to an extent that the effects of reducing the amount of field emission can be accomplished. For example, forced short circuit may be realized within a range of (k/4)λ±( 1/16)λ centering (k/4)λ.

The present invention may be embodied in other specific forms without departing from the spirit or essential characteristics thereof. The foregoing embodiments and modifications are therefore to be considered in all respects as illustrative and not restrictive, the scope of the present invention being indicated by the appended claims rather than by the foregoing description and all changes which come within the meaning and range of equivalency of the claims are therefore intended to be embraced therein.

1. A radio receiver comprising:
a reception antenna receiving a radio wave whose wavelength is γ to output an electrical signal depending on the received radio wave;
an amplifier amplifying the electrical signal outputted from the reception antenna; and
a cable connected via a connection terminal to the amplifier to transmit an electrical signal amplified by the amplifier, wherein the connection terminal is positioned at the amplifier so as to intervene between the cable and an inner amplifying inner amplifying circuit of the amplifier, only a first specified portion of the cable is short-circuited to a metal member in a range of signals of high frequencies to be transmitted through the cable, and the first specified portion is measured from the connection terminal so as to have a distance corresponding to (k/4)λ (k is an odd number).

2. The radio receiver according to claim 1, wherein the parameter k is 1.

3. The radio receiver according to claim 1, wherein the cable include a second portion of the cable specified farther than the first specified portion is also short-circuited in the range of signals of high frequencies.

4. The radio receiver according to claim 3, wherein the second specified portion of the cable is located far from the connection terminal by a distance corresponding to (j/4)λ (j is an odd number larger than k).

5. The radio receiver according to claim 1, wherein the cable is arranged in a straight form from the connection terminal to the first specified portion thereof.

6. The radio receiver according to claim 1, wherein the cable has an outer coating and the outer coating at the first and second specified portions are made to come in contact with the metal member so that the short circuit in the region of signals of high frequencies is realized.

7. The radio receiver according to claim 6, wherein at least one of the first and second specified portions are made to come in contact with the metal member using a clip catching the cable.

8. The radio receiver according to claim 6, wherein at least one of the first and second specified portions are made to come in contact with the metal member using a tape holing the cable to the metal body.

9. The radio receiver according to claim 6, wherein at least one of the first and second specified portions are made to come in contact with the metal member using a conductive member inserted between the cable and the metal body.

10. The radio receiver according to claim 2, wherein the cable include a second portion of the cable specified farther than the first specified portion is also short-circuited in the range of signals of high frequencies.

11. The radio receiver according to claim 10, wherein the second specified portion of the cable is located far from the connection terminal by a distance corresponding to (j/4)λ (j is an odd number larger than k).

12. The radio receiver according to claim 11, wherein the cable is arranged in a straight form from the connection terminal to the first and second specified portions thereof.

13. The radio receiver according to claim 12, wherein the cable has an outer coating and the outer coating at the first and second specified portions are made to come in contact with the metal member so that the short circuit in the region of signals of high frequencies is realized.

14. The radio receiver according to claim 13, wherein at least one of the first and second specified portions are made to come in contact with the metal member using a clip catching the cable.

15. The radio receiver according to claim 13, wherein at least one of the first and second specified portions are made to come in contact with the metal member using a tape holing the cable to the metal body.

16. The radio receiver according to claim 13, wherein at least one of the first and second specified portions are made to come in contact with the metal member using a conductive member inserted between the cable and the metal body.

17. The radio receiver according to claim 1, wherein a remaining portion of cable other than the first and second specified portions are separated from above the metal body.

18. The radio receiver according to claim 1, wherein the metal member is part of a vehicle in which the radio receiver is mounted.

19. The radio receiver according to claim 18, wherein the reception antenna is a planar antenna receiving the radio wave from a GPS (Global Positioning System).

20. The radio receiver according to claim 1, wherein the cable is a coaxial cable and the first and second specified portions are portions that realize a point-to-point contact with the metal member.
